(19) United States
(12) Patent Application Publication
(10) Pub. No.: US 2025/0058316 A1
(43) Pub. Date: Feb. 20, 2025

(54) HIGH VOLTAGE DRIVING USING TOP PLANE SWITCHING

(71) Applicant: Nuclera LTD, Cambridge (GB)

(72) Inventors: David Zhitomirsky, Billerica, MA (US); Richard J. Paolini, JR., Billerica, MA (US); Kenneth R. Crounse, Billerica, MA (US); Stephen J. Telfer, Billerica, MA (US); Analisa Lattes, Billerica, MA (US); Chris Hoogemoom, Billerica, MA (US); Seth J. Bishop, Billerica, MA (US)

(21) Appl. No.: 18/722,440

(22) PCT Filed: Dec. 22, 2022
(86) PCT No.: PCT/US2022/053807

§ 371 Date: Jun. 20, 2024

Related U.S. Application Data
(60) Provisional application No. 63/422,786, filed on Nov. 4, 2022.
(60) Provisional application No. 63/292,916, filed on Dec. 22, 2021.

(51) Int. Cl. B01L 3/00

(52) U.S. Cl. CPC B01L 3/50273; B01L 2300/0645; B01L 2400/0427

(57) ABSTRACT

Improved methods for driving an active matrix of pixel electrodes controlled with thin film transistors when the voltage on a top electrode is being altered between driving frames. The method is useful for electrowetting devices. In particular, the methods can provide for more consistent droplet movement when used with a digital microfluidic device based upon an active matrix of pixel electrodes.

### RELATED APPLICATIONS

This application claims priority to U.S. Provisional Patent Application No. 63/292,916, filed Dec. 22, 2021 and U.S. Provisional Patent Application No. 63/422,786, filed Nov. 4, 2022 each of which is incorporated by reference herein in its entirety.

### BACKGROUND

Digital microfluidic (DMF) devices use independent electrodes to propel, split, and join droplets in a confined environment, thereby providing a “lab-on-a-chip.” Digital microfluidic devices have been used to actuate a wide range of volumes (nanoliter nL to microliter μL) and are alternatively referred to as electrowetting on dielectric, or “EWoD,” to further differentiate the method from competing microfluidic systems that rely on electrophoretic flow and/or micropumps. In electrowetting, a continuous or pulsed electrical signal is applied to a droplet, leading to switching of its contact angle. Liquids capable of electrowetting a hydrophobic surface often include a polar solvent, such as water or an ionic liquid, and often feature ionic species, as is the case for aqueous solutions of electrolytes. A 2012 review of the electrowetting technology was provided by Wheeler in “Digital Microfluidics,” Annu. Rev. Anal Cher. 2012, 5:413-40. The technique allows sample preparation, assays, and synthetic chemistry to be performed with tiny quantities of both samples and reagents.

### SUMMARY

In some embodiments, the present disclosure provides improved methods of driving an electrowetting device and electrowetting devices using drive methods taught herein. In some embodiments, an electrowetting device including a top electrode, a backplane, and a microfluidic workspace between the top electrode and the backplane. The backplane includes an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode. A controller provides time-dependent voltages to the gate line, the scan line, the top electrode, and the storage capacitor, and a first side of the storage capacitor is coupled to the pixel electrode and a second side of the storage capacitor is coupled to the controller. The controller the is configured or programmed to perform top plane switching to drive the electrowetting device by: driving the top electrode with a first voltage; driving the plurality of gate lines with a pulsed waveform to open the plurality of TFTs; driving the plurality of storage capacitors and the plurality of scan lines with a low level voltage for at least one period of the pulsed waveform; and driving the top electrode with a second voltage.

In some embodiments, the present disclosure provides a method of driving an electrowetting device including a top electrode, a backplane, and a microfluidic workspace between the top electrode and the backplane. The backplane includes an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode. A controller provides time-dependent voltages to the gate line, the scan line, the top electrode, and the storage capacitor, and a first side of the storage capacitor is coupled to the pixel electrode and a second side of the storage capacitor is coupled to the controller. The method of driving includes a) providing a first high voltage to the scan line and a first low voltage to the top electrode and the second side of the storage capacitor, b) providing a first gate pulse sufficient to open the TFT, c) after the first gate pulse, providing a zero voltage to the scan line, the top electrode and the second side of the storage capacitor, d) providing a second gate pulse sufficient to open the TFT, e) after the second gate pulse, providing a second low voltage to the scan line and a second high voltage to the top electrode and the second side of the storage capacitor, and f) providing a third gate pulse sufficient to open the TFT.

In some embodiments, steps a)-f) are completed in three subsequent frames. In some embodiments, the top electrode is light-transmissive. In some embodiments, the top electrode and the second side of the storage capacitor are electrically coupled to a common node. In some embodiments, the TF is fabricated from amorphous silicon. In some embodiments, the first and second high voltage are +15V. In some embodiments, the first and second low voltages are −15V. In some embodiments, the backplane and the top electrode are coated with a hydrophobic material, wherein the hydrophobic materials are adjacent the microfluidic workspace. In some embodiments, the backplane additionally comprises a dielectric layer between the pixel electrodes and the hydrophobic material. In some embodiments, the microfluidic workspace further comprises a plurality of aqueous droplets surrounded by a continuous hydrophobic medium.

In some embodiments, the present disclosure provides a method of driving an electrowetting device including a top electrode, a backplane, and a microfluidic workspace between the top electrode and the backplane. The backplane includes an array of pixel electrodes, wherein each pixel electrode is coupled to a thin film transistor (TFT) and a storage capacitor, the TFT including a source, a gate, and a drain wherein the gate is coupled to a gate line, the source is coupled to a scan line, and the drain is coupled to the pixel electrode. A controller provides time-dependent voltages to the gate line, the scan line, the top electrode, and the storage capacitor, and a first side of the storage capacitor is coupled to the pixel electrode and a second side of the storage capacitor is coupled to the controller. The method of driving comprises a) providing a first high voltage to the scan line and a first low voltage to the top electrode and the second side of the storage capacitor, b) providing a first gate pulse sufficient to open the TFT, c) after the first gate pulse, providing a second low voltage to the scan line, d) providing a second gate pulse sufficient to open the TFT, e) after the second gate pulse, providing a second high voltage to the top electrode and the second side of the storage capacitor, and f) providing a third gate pulse sufficient to open the TFT.

In some embodiments, steps a)-f) are completed in three subsequent frames. In some embodiments, the top electrode is light-transmissive. In some embodiments, the top electrode and the second side of the storage capacitor are electrically coupled to a common node. In some embodiments, the TT is fabricated from amorphous silicon. In some embodiments, the first and second high voltage are +15V. In some embodiments, the first and second low voltages are −15V. In some embodiments, the backplane and the top electrode are coated with a hydrophobic material, wherein the hydrophobic materials are adjacent the microfluidic workspace. In some embodiments, the backplane additionally comprises a dielectric layer between the pixel electrodes and the hydrophobic material. In some embodiments, the microfluidic workspace further comprises a plurality of aqueous droplets surrounded by a continuous hydrophobic medium.

In some embodiments, a method of driving an electrowetting device including a top electrode, a backplane, and a microfluidic workspace between the top electrode and the backplane. The backplane includes an array of pixel electrodes, wherein each pixel electrode is coupled to a thin film transistor (ITT) and a storage capacitor, the TFT including a source, a gate, and a drain, wherein the gate is coupled to a gate line, the source is coupled to a scan line, and the drain is coupled to the pixel electrode. A controller provides time-dependent voltages to the gate line, the scan line, the top electrode, and the storage capacitor, and a first side of the storage capacitor is coupled to the pixel electrode and a second side of the storage capacitor is coupled to the controller. The method of driving comprises a) providing a first high voltage to the scan line and a first low voltage to the top electrode and the second side of the storage capacitor, b) providing a first gate pulse sufficient to open the TFT, c) after the first gate pulse, providing a second high voltage to the top electrode and the second side of the storage capacitor, d) providing a second gate pulse sufficient to open the TFT, e) after the second gate pulse, providing a second low voltage to the scan line, and f) providing a third gate pulse sufficient to open the TFT.

In some embodiments, steps a)-f) are completed in three subsequent frames. In some embodiments, the top electrode is light-transmissive. In some embodiments, the top electrode and the second side of the storage capacitor are electrically coupled to a common node. In some embodiments, the TFT is fabricated from amorphous silicon. In some embodiments, the first and second high voltage are +15V. In some embodiments, the first and second low voltages are −15V. In some embodiments, the backplane and the top electrode are coated with a hydrophobic material, wherein the hydrophobic materials are adjacent the microfluidic workspace. In some embodiments, the backplane additionally comprises a dielectric layer between the pixel electrodes and the hydrophobic material. In some embodiments, the microfluidic workspace further comprises a plurality of aqueous droplets surrounded by a continuous hydrophobic medium.

In some embodiments, a method of driving an electrowetting device comprising a top electrode, a backplane, and a microfluidic workspace between the top electrode and the backplane, the backplane including an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode, wherein a controller provides time-dependent voltages to the gate line, the scan line, the top electrode, and the storage capacitor, wherein a first side of the storage capacitor is coupled to the pixel electrode and a second side of the storage capacitor is coupled to the controller, the method of driving comprising (in order):
a) providing a first high voltage to the scan line and a first low voltage to the top electrode and the second side of the storage capacitor;
b) providing a first gate pulse sufficient to open the TFT;
c) after the first gate pulse, providing a zero voltage to the scan line, the top electrode and the second side of the storage capacitor;
d) providing a second gate pulse sufficient to open the TFT;
e) after the second gate pulse, providing a second low voltage to the scan line and a second high voltage to the top electrode and the second side of the storage capacitor; and
f) providing a third gate pulse sufficient to open the TFT.

In some embodiments, a method of driving an electrowetting device comprising a top electrode, a backplane, and a microfluidic workspace between the top electrode and the backplane, the backplane including an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode, wherein the controller provides time-dependent voltages to the gate line, the scan line, and the top electrode in order to execute the following steps (in order):
a) provide a first voltage to the top electrode;
b) provide a specific voltage to each electrode of the array of pixel electrodes in a first sequential order, wherein at least 10 pixels of the array have specific voltages different from the majority of the pixel electrodes;
c) provide a specific voltage to each electrode of the array of pixel electrodes in a second sequential order, wherein the order of providing specific voltages to pixel electrodes in the second sequential order is a reverse order of the first sequential order, and wherein each pixel receives the same specific voltage in both the first sequential order and the second sequential order; and
d) provide a second voltage different from the first voltage to the top electrode, wherein the pixel electrodes do not receive another voltage from the controller between steps (b) and (c).

### BRIEF DESCRIPTION OF DRAWINGS

FIG. 1 illustrates an exemplary equivalent circuit of a single pixel of an EWoD device.

FIG. 2A is a schematic cross-section of a cell of an embodiment of an electrowetting on dielectric (EWoD) device.

FIG. 2B is a schematic cross-section of a cell of an embodiment of an electrowetting on dielectric (EWoD) device illustrating EWoD operation with a fixed voltage top electrode.

FIG. 2C is a schematic cross-section of a cell of an embodiment of an electrowetting on dielectric (EWoD) device illustrating EWoD operation with top-plane switching (TPS), i.e., a variable voltage applied to the top electrode to increase the total voltage differential between the top electrode and the backplane pixels.

FIG. 3 is a diagrammatic view of an exemplary driving system for controlling voltages on pixel electrodes in an active matrix device. The resulting voltages can be used to propel aqueous droplets on a hydrophobic surface.

FIG. 4 illustrates an exemplary equivalent circuit of a single pixel when the storage capacitor (V_{com}) and the top electrode (Vₜₒₚ) are tied together (both V_{com}).

FIG. 5A illustrates the voltage “seen” by a pixel electrode when top plane switching is used without intervening zero frames.

FIG. 5B illustrates the voltages at various points in exemplary equivalent circuit of three different pixels driven as shown in FIG. 5A.

FIG. 5C illustrates the voltages at various points in exemplary equivalent circuit of a three different pixels driven as shown in FIG. 5A.

FIG. 5D illustrates the voltages at various points in exemplary equivalent circuit of a three different pixels after driving as in FIG. 5A and attempting to return to the initial state of V_{com}=−15V.

FIG. 6A illustrates a typical “left to right, top to bottom” scan pathway used with active matrix backplanes.

FIG. 6B illustrates that using a two-step, “left to right, top to bottom” scan pathway combined with a supplemental “right to left, bottom to top” scan pathway results in an array of pixels having an electric field environment with less positional variation,

FIG. 7A illustrates the voltage “seen” by a pixel electrode when top plane switching is used but V_{com} and V_{S} are returned to zero volts for a frame between switching the top plane from low voltage to high voltage.

FIG. 7B illustrates the voltages at various points in exemplary equivalent circuit of a three different pixels driven as shown in FIG. 7A.

FIG. 7C illustrates the voltages at various points in exemplary equivalent circuit of a three different pixels driven as shown in FIG. 7A.

FIG. 7D illustrates the voltages at various points in exemplary equivalent circuit of a three different pixels driven as shown in FIG. 7A. The gate of the top pixel has already opened and closed while V_{com} is at −15V. The gate of the middle pixel is currently open while V_{com} is at −+15V. The gate of the bottom pixel has not yet opened while V_{com} is at +15V.

FIG. 7E illustrates the voltages at various points in exemplary equivalent circuit of a three different pixels driven as shown in FIG. 7A.

FIG. 7F illustrates the voltages at various points in exemplary equivalent circuit of a three different pixels being returned to the condition of FIG. 7B.

FIG. 8A illustrates the voltage “seen” by a pixel electrode when top plane switching is used but V_{com} and V_{S} are “shorted” to each other between switching the top plane from low voltage to high voltage. (Often, V_{com} and V_{S} are not actually shorted but provided the same voltage from the controller.)

FIG. 8B illustrates the voltages at various points in exemplary equivalent circuit of a three different pixels driven as shown in FIG. 8A.

FIG. 8C illustrates the voltages at various points in exemplary equivalent circuit of a three different pixels driven as shown in FIG. 8A.

FIG. 8D illustrates the voltages at various points in exemplary equivalent circuit of a three different pixels driven as shown in FIG. 8A.

FIG. 8E illustrates the voltages at various points in exemplary equivalent circuit of a three different pixels driven as shown in FIG. 8A.

FIG. 8F illustrates the voltages at various points in exemplary equivalent circuit of a three different pixels being returned to the condition of FIG. 8B.

### DETAILED DESCRIPTION

The present disclosure provides improved devices and methods of driving electrowetting devices with so-called top-plane switching, i.e., where the voltage on the top electrode is varied during the course of a device update. In some embodiments, the present disclosure is used with electrowetting on dielectric (EWoD) devices whereby localized changes in surface energy are used to propel aqueous droplets across a matrix of electrodes. Additionally, by providing suitably high voltage levels, in addition to moving droplets, it is possible to split droplets and combine droplets, thereby enabling a number of laboratory functions in a rather small space with very small amounts of reagents and/or sample.

Often, EWoD devices include a stack of an electrode, an insulating dielectric layer, and a hydrophobic layer providing a working surface. A droplet is placed on the working surface, and the electrode, once actuated, can cause the droplet to deform and wet or de-wet from the surface depending on the applied voltage. Most of the literature reports on EWoD involve so-called “direct drive” devices (a.k.a. “segmented” devices), whereby ten to several hundred electrodes are directly driven with a controller. While segmented devices are easy to fabricate, the number of electrodes is limited by space and driving constraints. Accordingly, it is not possible to perform massive parallel assays, reactions, etc. in direct drive devices. In comparison, “active matrix” devices (a.k.a. active matrix EWoD, a.k.a. AM-EWoD) devices can have many thousands, hundreds of thousands or even millions of addressable electrodes. In AM-EWoD devices electrodes are often switched by thin-film transistors (TFTs) and droplet motion is programmable so that AM-EWoD) arrays can be used as general purpose devices that allow great freedom for controlling multiple droplets and executing simultaneous analytical processes.

TFT-based thin film electronics may be used to control the addressing of voltage pulses to an EWoD array by using circuit arrangements very similar to those employed in AM display technologies, i.e., as discussed above. Tl arrays are highly desirable for this application, due to having thousands of addressable pixels, thereby allowing mass parallelization of droplet procedures. Driver circuits can be integrated onto the AM-EWoD array substrate, and TFT-based electronics are well suited to the AM-EWoD application. TFTs can be made using a wide variety of semiconductor materials. A common material is silicon. The characteristics of a silicon-based TFT depend on the silicon's crystalline state, that is, the semiconductor layer can be either amorphous silicon (a-Si), microcrystalline silicon, or it can be annealed into low-temperature polysilicon (LTPS). TFTs based on a-Si are cheap to produce so that relatively large substrate areas can be manufactured at relatively low cost. One downside of TFTs based upon a-Si is that the bias across the TFT is often limited to no more than 45V. Beyond 45V, the transistor can fail or have “breakthrough” during which excess current moves through the transistor and charges, e.g., a pixel electrode beyond the desired level. More exotic materials, such as metal oxides may also be used to fabricate thin film transistor arrays, and achieve higher voltages, but the fabrication costs of such devices is often high because of the specialized equipment needed to handle/deposit the metal oxides.

For active matrix devices, the drive signals are often output from a controller to gate and scan drivers that, in turn, provide the required current-voltage inputs to active the various TT in the active matrix. However, controller-drivers capable of receiving, e.g., image data, and outputting the necessary current-voltage inputs to active the TFTs are commercially available. Most active matrices of thin-film-transistors are drive with line-at-a-time (a.k.a., line-by-line) addressing, which is used in the vast majority of LCD displays. In such systems one or more controllers are used to deliver a voltage to a series of scan lines and a series of gate lines, which are often arranged perpendicularly in a grid across the backplane. Other controllers, or the same controller, will also provide voltages to the top electrode as well as a common voltage (V_{com}) provided to a storage capacitor that is often associated with a given pixel electrode.

“Droplet” means a volume of liquid that electrowets a hydrophobic surface and is at least partially bounded by carrier fluid. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and/or one more nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes.

The terms “DMF device”, “EWoD device”, and “Droplet actuator” mean a device for manipulating droplets.

“Droplet operation” means any manipulation of one or more droplets on a microfluidic device. A droplet operation may, for example, include: loading a droplet into the microfluidic device; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet. A with droplet B,” can be achieved by transporting droplet. A into contact with a stationary droplet B, transporting droplet B into contact with a stationary droplet A, or transporting droplets. A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a power amplifier that accepts a low-power input from a controller, for instance a microcontroller integrated circuit (IC), and produces a high-current drive input for the gate of a high-power transistor such as a TT coupled to an EWoD pixel electrode. “Source driver” is a power amplifier producing a high-current drive input for the source of a high-power transistor. “Top plane common electrode driver” is a power amplifier producing a high-current drive input for the top plane electrode of an EWoD device.

“Waveform” denotes the entire voltage against time curve used to actuate a pixel in a microfluidic device. Often, such a waveform will comprise a plurality of waveform elements, where these elements are essentially rectangular (i.e., where a given element comprises application of a constant voltage for a period of time). The elements may be called “voltage pulses” or “drive pulses”. The term “drive scheme” denotes a set of waveforms sufficient to effect a manipulation of one or more droplets in the course of a specific droplet operation. The term “frame” denotes a single update of all the pixel rows in a microfluidic device.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

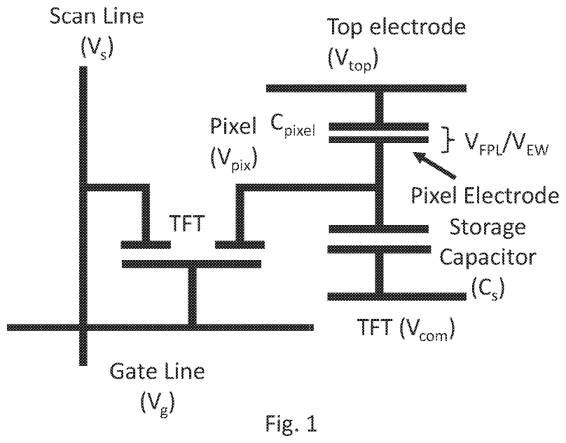

Amorphous silicon TFT backplanes usually have only one transistor per pixel electrode or propulsion electrode. As illustrated in in FIG. 1, each transistor (TFT) is connected to a gate line, a data line, and a pixel electrode (propulsion electrode). When there is large enough positive voltage on the TFT gate (or negative depending upon the type of transistor) then there is low impedance between the scan line and pixel electrode coupled to the TF T drain (i.e., Vg “ON” or “OPEN” state), so the voltage on the scan line is transferred to the electrode of the pixel. When there is a negative voltage on the TFT gate, however, then there is high impedance and voltage is stored on the pixel storage capacitor and not affected by the voltage on the scan line as the other pixels are addressed (i.e., Vg “OFF” or “CLOSED”). Thus, ideally, the TFT should act as a digital switch. In practice, there is still a certain amount of resistance when the TFT is in the “ON” setting, so the pixel takes some time to charge. Additionally, voltage can leak from V_{S} to Vₚᵢₓ when the TFT is in the “OFF” setting, causing cross-talk. Increasing the capacitance of the storage capacitor Cₛ reduces cross-talk, but at the cost of rendering the pixels harder to charge, and increasing the charge time. As shown in FIG. 1, a separate voltage (V_{TOP}) is provided to the top electrode, thus establishing an electric field between the top electrode and the pixel electrode (V_{FPL} or V_{EW}). Ultimately, it is the value of V_{FPL} or V_{EW} that determines the propulsion conditions in an electrowetting operation. While a first side of the storage capacitor is coupled to the pixel electrode, a second side of the storage capacitor is coupled to a separate line (V_{COM}) that allows the charge to be removed from the pixel electrode. See, for example, U.S. Pat. No. 7,176,880, which is incorporated by reference in its entirety, [In some embodiments, N-type semiconductor (e.g., amorphous silicon) may be used to from the transistors and the “select” and “non-select” voltages applied to the gate electrodes can be positive and negative, respectively.] In some embodiments V_{COM} may be grounded, however there are many different designs for draining charge from the charge capacitor, e.g., as described in U.S. Pat. No. 10,037,735, which is incorporated by reference in its entirety.

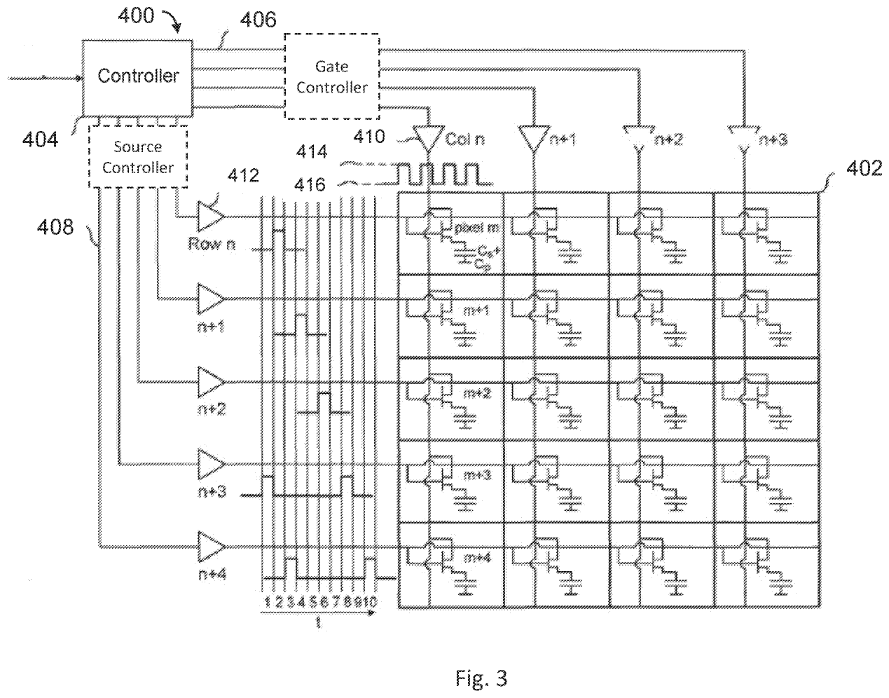

Most commercial electrophoretic displays use amorphous silicon based thin-film transistors (TFTs) in the construction of active matrix backplanes (See FIG. 3) because of the wider availability of fabrication facilities and the costs of the various starting materials. Unfortunately, amorphous silicon thin-film transistors become unstable when supplied gate voltages that would allow switching of voltages higher than about +/−15V. Nonetheless, as described below, the performance of ACeP is improved when the magnitudes of the high positive and negative voltages are allowed to exceed +/−15V. Accordingly, as described in previous disclosures, improved performance is achieved by additionally changing the bias of the top light-transmissive electrode with respect to the bias on the backplane pixel electrodes, also known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451.

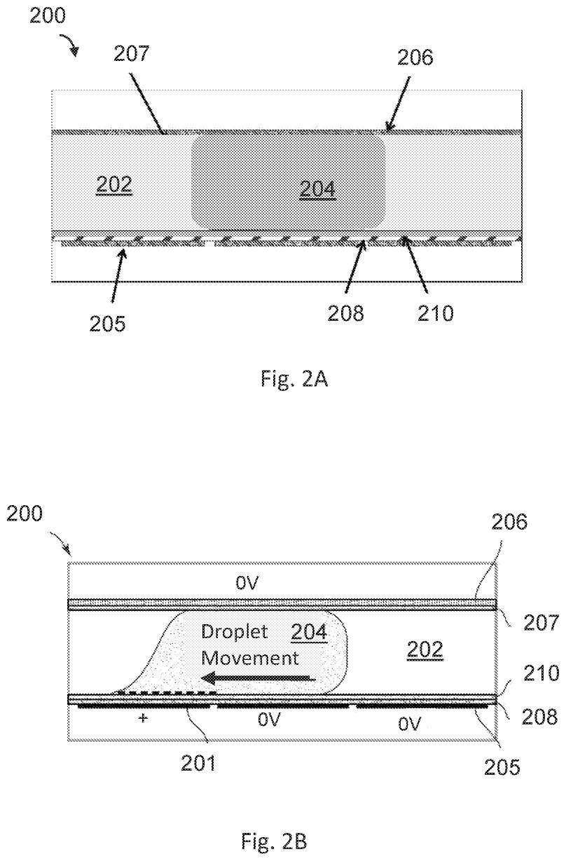

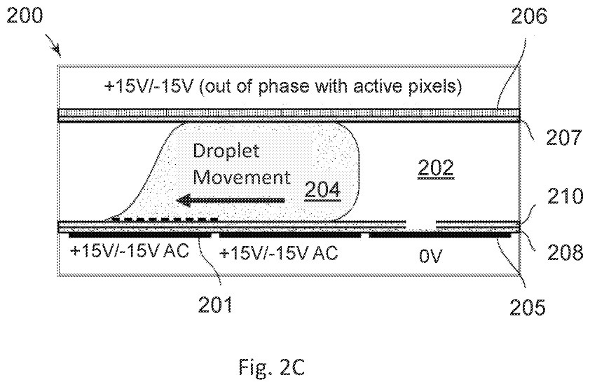

An AM-EWoD device consists of a thin film transistor backplane with an exposed array of regularly shaped electrodes that may be arranged as pixels. The pixels may be controllable as an active matrix, thereby allowing for the manipulation of sample droplets. The array is usually coated with a dielectric material, followed by a coating of hydrophobic material. The fundamental operations of a conventional EWoD device are illustrated in the sectional images of FIG. 2A-2C. FIG. 2A shows a diagrammatic cross-section of the cell of an example conventional EWoD device where droplet 204 is surrounded on the sides by carrier fluid 202 and sandwiched between top hydrophobic layer 207 and bottom hydrophobic layer 210. Propulsion electrodes 205 can be driven directly, e.g., by separate control circuits, or the electrodes can be switched by transistor arrays arranged to be driven with scan (a.k.a. data, a.k.a. source) lines and gate (a.k.a. select) lines. Typical cell spacing (i.e., the distance between the top and bottom hydrophobic layers is usually in the range of about 100 microns (μm) to about 500 μm.

Often a dielectric layer 208 is deposited over the propulsion electrodes 205 as well as the associated gate and scan lines. The dielectric 208 should be thin enough and have a dielectric constant compatible with low voltage AC driving, such as available from conventional image controllers for LCD or EPD displays. For example, the dielectric layer 208 may comprise a layer of approximately 20-40 nm SiO₂ topped over-coated with 200-400 nm plasma-deposited silicon nitride. Alternatively, the dielectric layer 208 may comprise atomic-layer-deposited Al₂O₃ between 5 and 500 nm thick, preferably between 150 and 350 nanometers (nm) thick.

The hydrophobic layer 207/210 can be constructed from one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), ETFE (polyethylenetetrafluoroethylene), and ECTFE (polyethyleneechlorotrifluoroethylene). Commercially available fluoropolymers Teflon®AF (Sigma-Aldrich, Milwaukee, WI) and FluoroPel™ coatings from Cytonix (Beltsville, ND), which can be spin coated over the dielectric layer 208. An advantage of fluoropolymer films is that they can be highly inert and can remain hydrophobic even after exposure to oxidizing treatments such as corona treatment and plasma oxidation. Coatings having higher contact angles may be fabricated from one or more superhydrophobic materials. Contact angles on superhydrophobic materials often exceed 150°, meaning that only a small percentage of a droplet base is in contact with the surface. This imparts an almost spherical shape to the water droplet. Certain fluorinated silanes, perfluoroalkyls, perfluoropolyethers and RF plasma-formed superhydrophobic materials have found use as coating layers in electrowetting applications and render it relatively easier to slide along the surface. Some types of composite materials are characterized by chemically heterogeneous surfaces where one component provides roughness and the other provides low surface energy so as to produce a coating with superhydrophobic characteristics. Biomimetic superhydrophobic coatings rely on a delicate micro or nano structure for their repellence, but care should be taken as such structures tend to be easily damaged by abrasion or cleaning.

While it is possible to have a single layer for both the dielectric and hydrophobic functions, such layers often need thick inorganic layers (to prevent pinholes) with resulting low dielectric constants, thereby requiring more than 100V for droplet movement. To achieve low voltage actuation, it is usually better to have a thin inorganic layer for high capacitance and to be pinhole free, topped by a thin organic hydrophobic layer. With this combination it is possible to have electrowetting operation with voltages in the range +/−10 to +/−50V, which is in the range that can be supplied by conventional TFT arrays.

As discussed previously, there are two “modes” of driving EWoDs: “DC Top Plane” and “Top Plane Switching (TPS)”. FIG. 2B illustrates EWoD operation in DC Top Plane mode, where the top plane electrode 206 is set to a potential of zero volts. As a result, the voltage applied across the cell is the voltage on the active propulsion electrode, that is, pixel 201 having a different voltage to the top plane so that conductive droplets are attracted to the electrode. This limits driving voltages in the EWoD cell to about ±15V because in a-Si TFTs the maximum voltage is in the range from about 15V to about 20V due to TFT electrical instabilities tinder high voltage operation. The alternative, Top-Plane Switching is shown in FIG. 2C, in which the driving voltage is effectively doubled to ±30V by powering the top electrode out of phase with active pixels, such that the top plane voltage is additional to the voltage supplied by the TFT.

To obtain a high-resolution array, individual pixels must be addressable without interference from adjacent pixels. One way to achieve this objective is to provide an array of non-linear elements, such as transistors or diodes, with at least one non-linear element associated with each pixel, to produce an active matrix array 400, shown in FIG. 3 (which is a diagrammatic view of an exemplary driving system for controlling voltages on pixel electrodes in an active matrix device. The resulting voltages can be used to propel aqueous droplets on a hydrophobic surface). An addressing or pixel electrode, which addresses one pixel, is fabricated on a substrate 402 and connected to an appropriate voltage source 406 through the associated non-linear element. It is to be understood that FIG. 3 is an illustration of the layout of an active matrix backplane 400 but that, in reality, the active matrix has depth and some elements, e.g., the TFT, may actually be underneath the pixel electrode, with a via providing an electrical connection from the drain to the pixel electrode above.

Conventionally, in high resolution arrays, the pixels are arranged in a two-dimensional array of rows and columns, such that any specific pixel is uniquely defined by the intersection of one specified row and one specified column. The sources of all the transistors in each column are connected to a single column (scan) line 406, while the gates of all the transistors in each row are connected to a single row (gate) line 408; again the assignment of sources to rows and gates to columns is conventional but essentially arbitrary, and could be reversed if desired. The gate lines 408 are connected to a gate line driver 412, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column scan lines 406 are connected to scan line drivers 410, which place upon the various scan lines 406 voltages selected to drive the pixels in the selected row to their desired optical states. (The aforementioned voltages are relative to a common top electrode, and is not shown in FIG. 3.) After a pre-selected interval known as the “line address time” the selected row is deselected, the next row is selected, and the voltages on the column drivers are changed so that the next line of the array is driven. This process is repeated so that the entire array is driven in a row-by-row manner. More details of this row-by-row driving are discussed below.

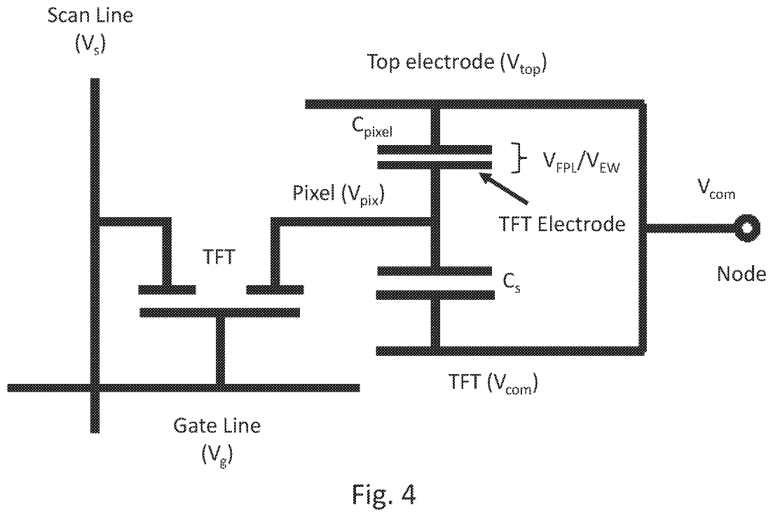

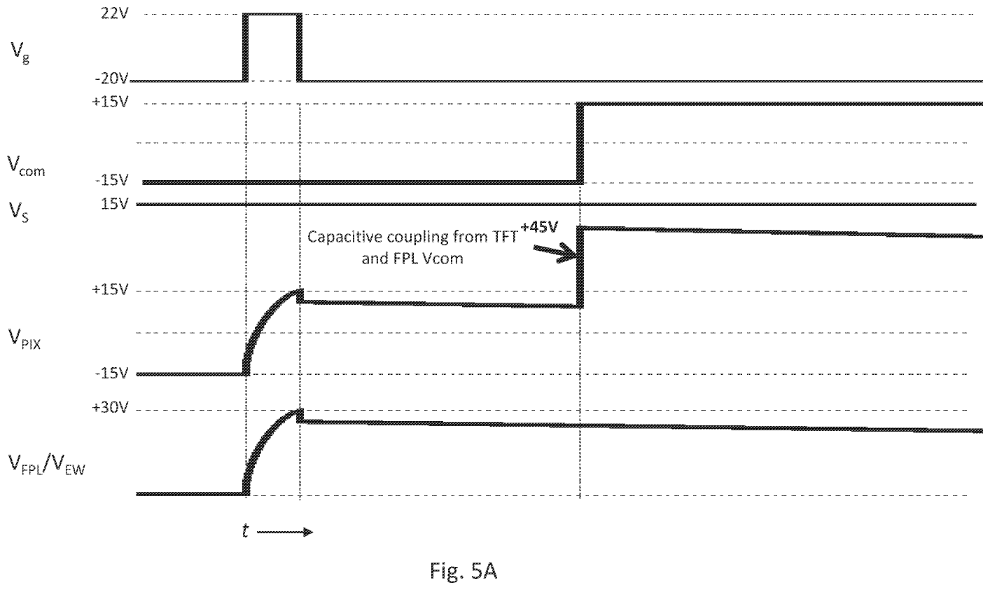

An issue with top plane switching is that when the top plane is switched from a first state, e.g., −15V to a second state +15V the droplets between the top plane and the pixel electrode (i.e., V_{FPL}/V_{EW}) will experience a huge swing in electric field, which may result in the pixel not achieving the correct impulse during that frame. Thus, if V_{TOP} is changed and V_{COM} is not compensated, a pixel may not achieve the correct color, or a droplet may not move as quickly as is anticipated. To overcome this dramatic shift, the V_{COM} and V_{TOP} lines are often tied together, e.g., through a common node, as shown in FIG. 4, so that when the gate is opened, the relative change in V_{FPL}/V_{EW} is maintained as expected.

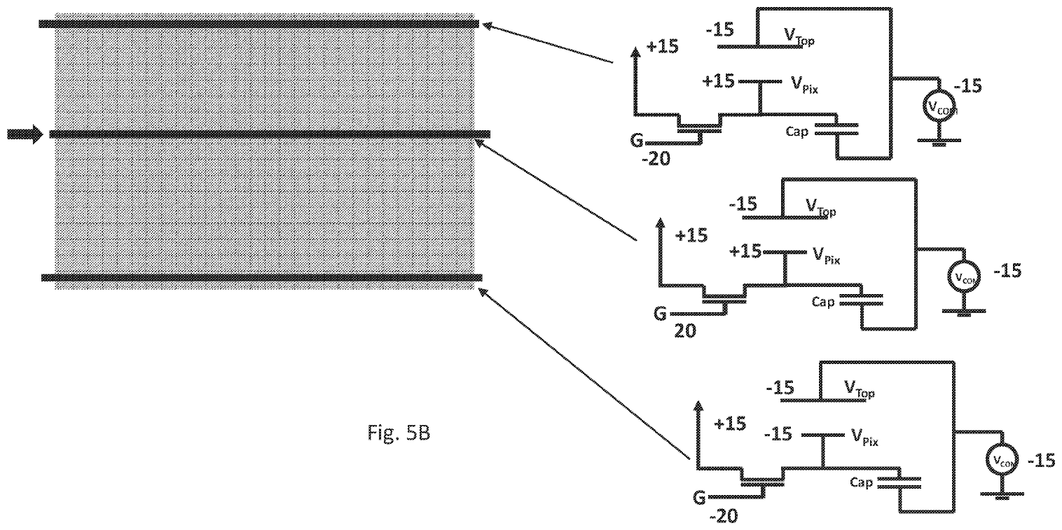

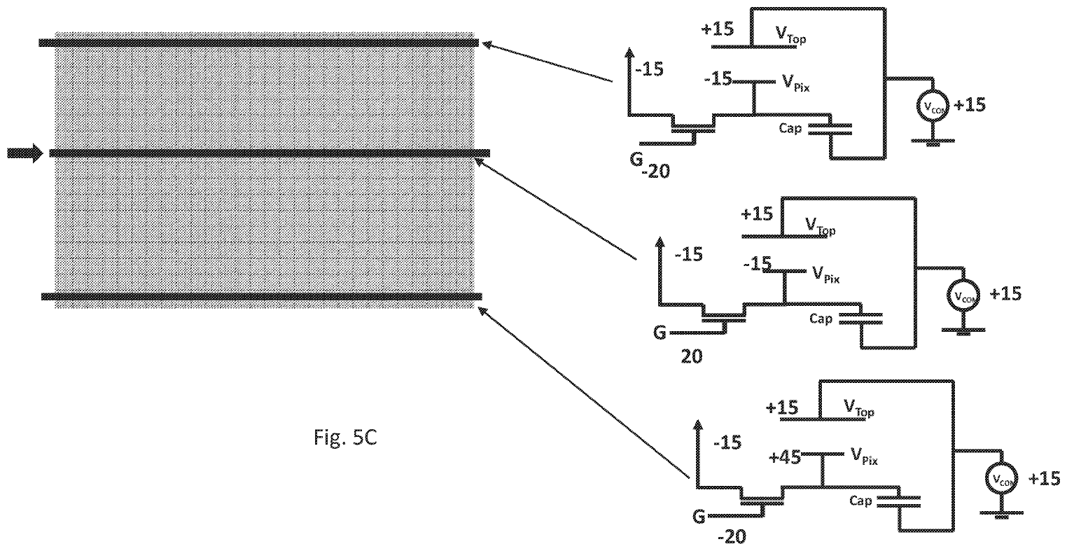

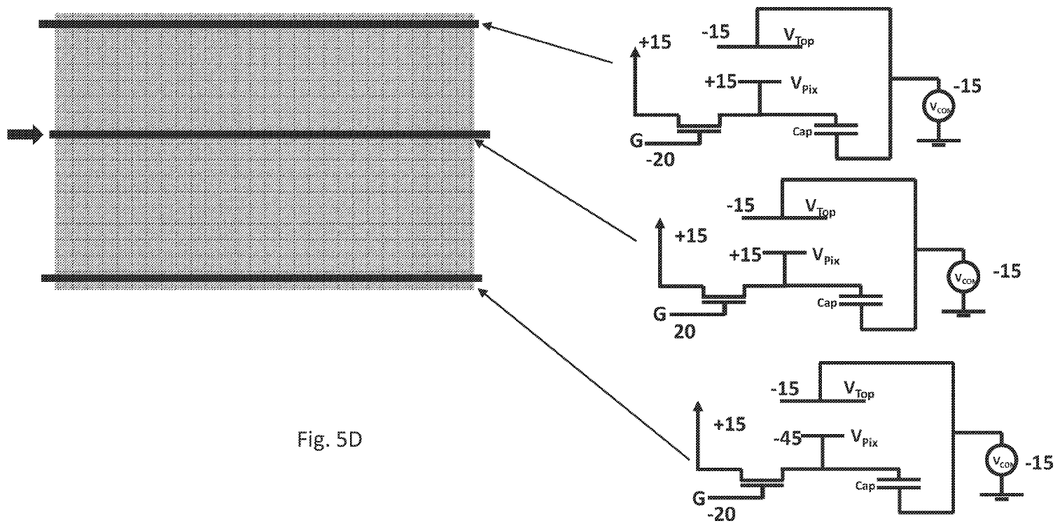

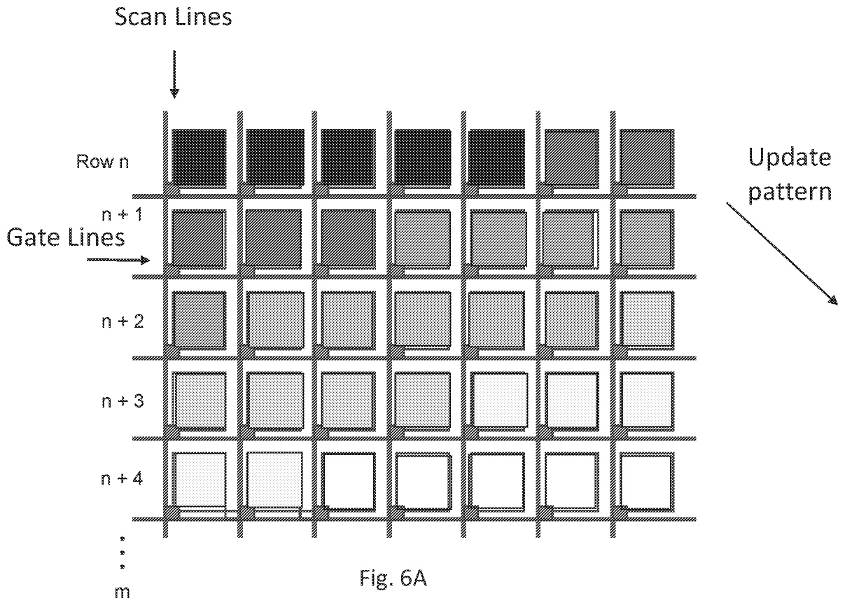

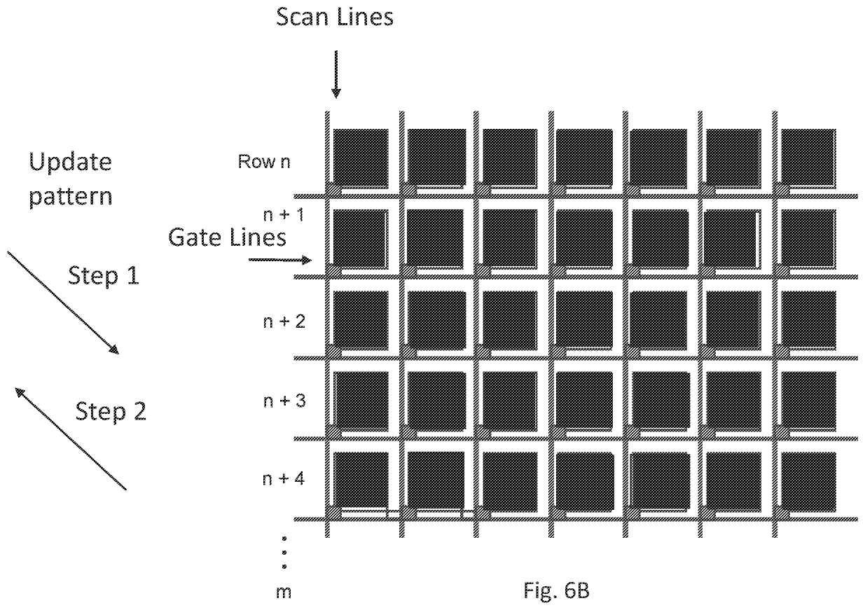

Nonetheless, as explained in FIGS. 5A-5D and 6, tying together V_{TOP} and V_{COM} does not solve the problems completely. First, for particular voltage combinations and for particular pixels in an array, the pixel electrode and TFT materials can undergo electric fields that are outside of the normal operational boundaries. This may cause current leakage through the transistor which results in unwanted droplet driving and/or drives electrochemical reactions between the pixel electrode materials and the surrounds, which are often actually grounded (or close to). Additionally, when the devices include layers of adhesives with conductive materials, the instantaneous high voltages can (rarely) create shorts through the conductive materials with a path to ground.

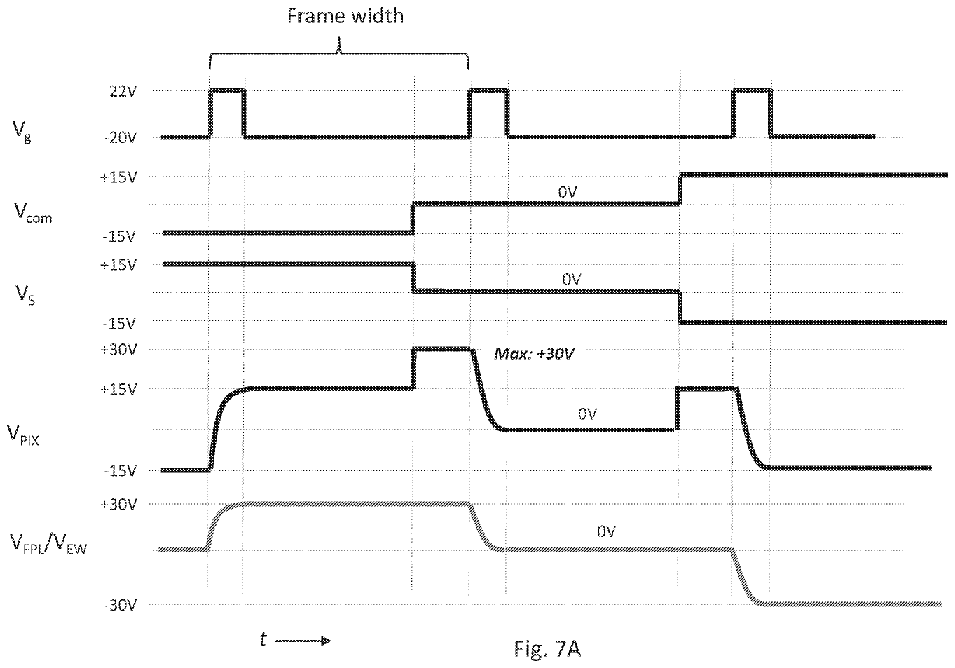

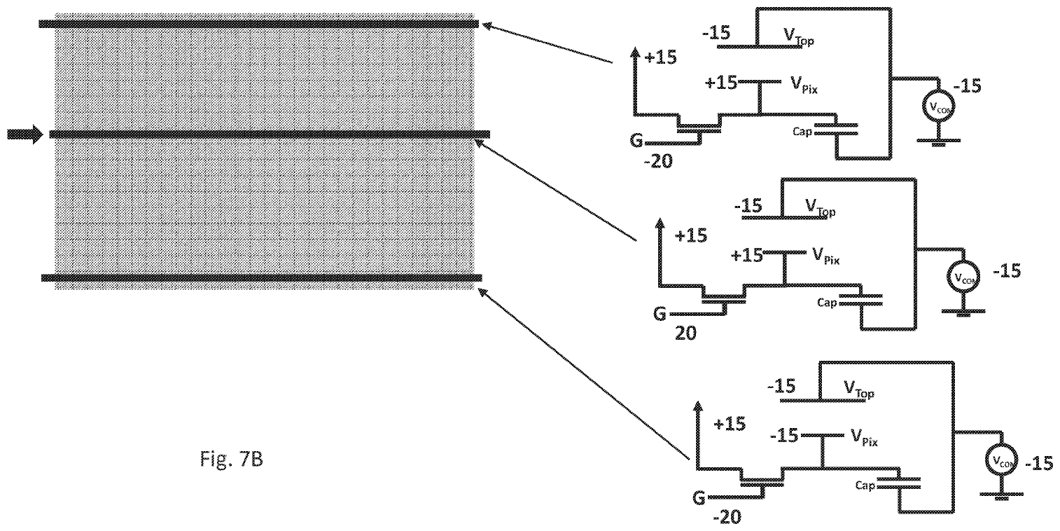

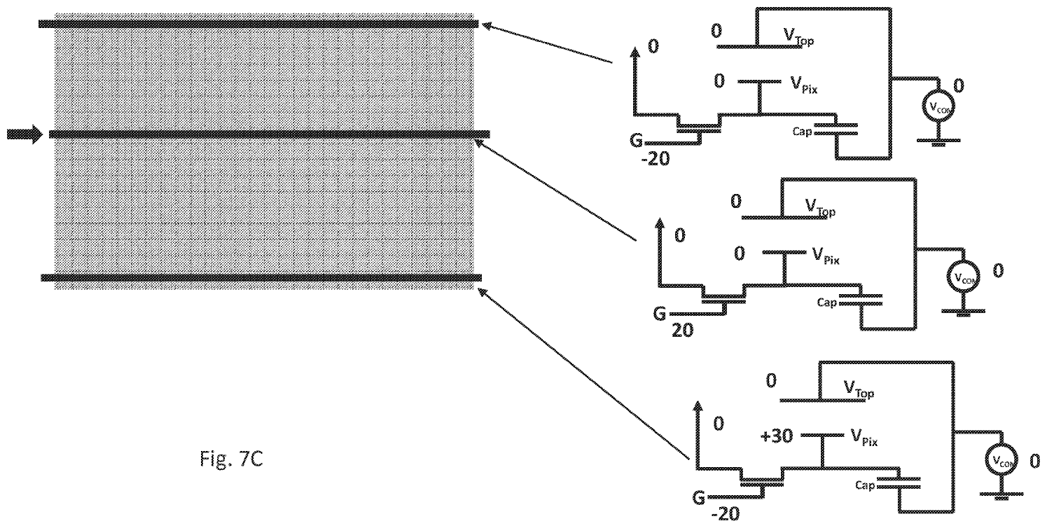

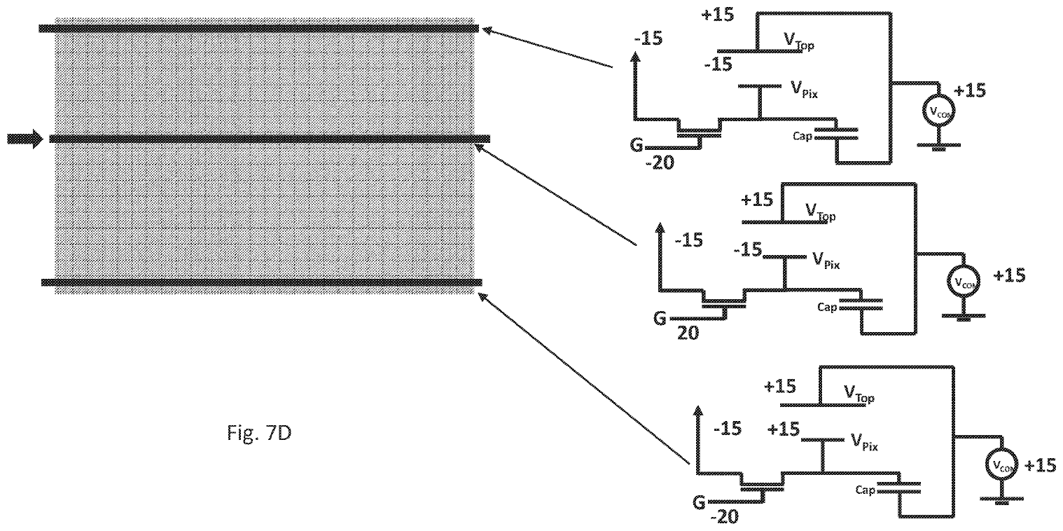

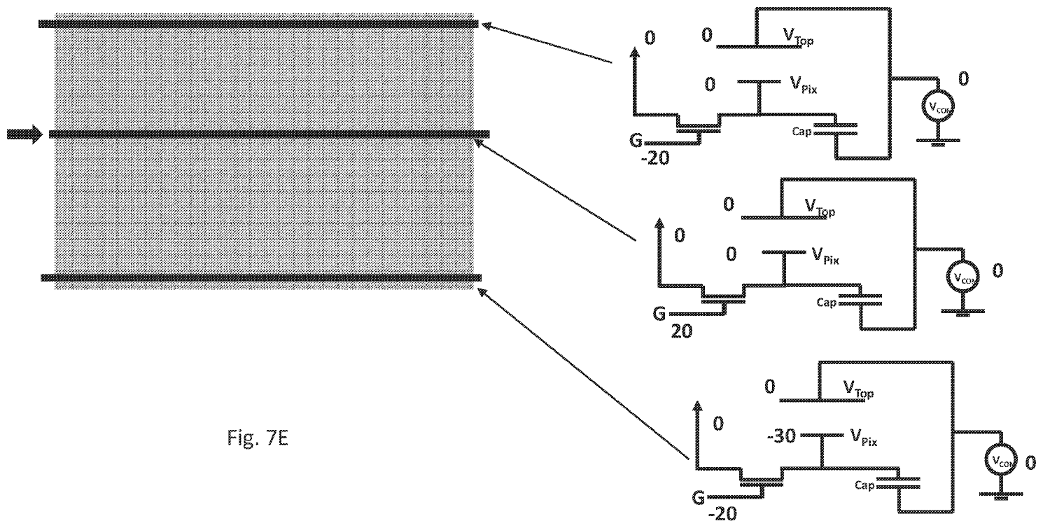

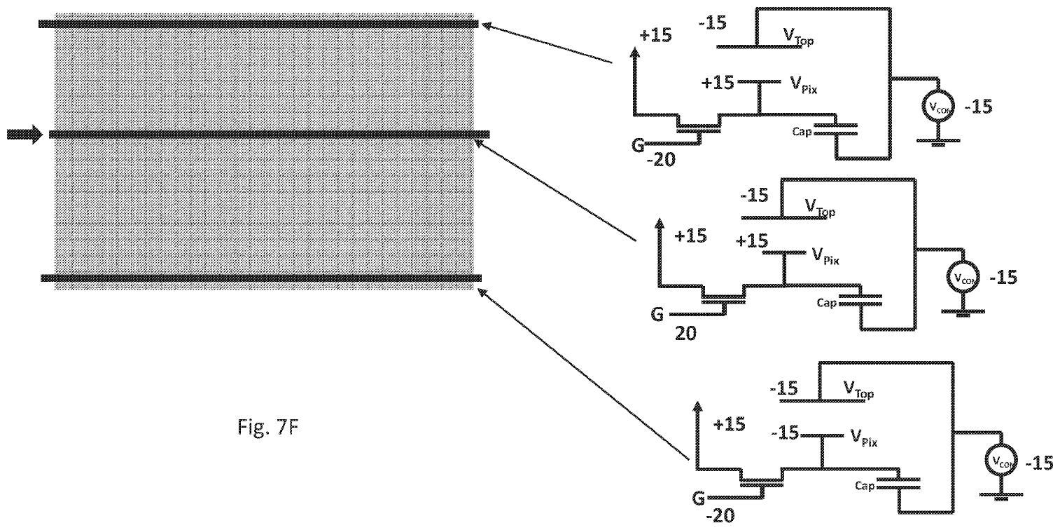

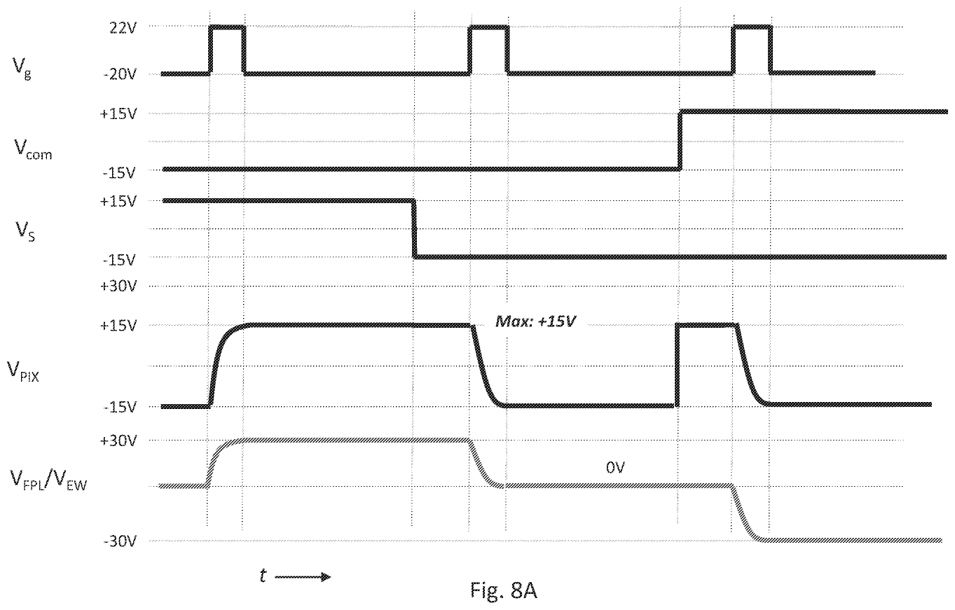

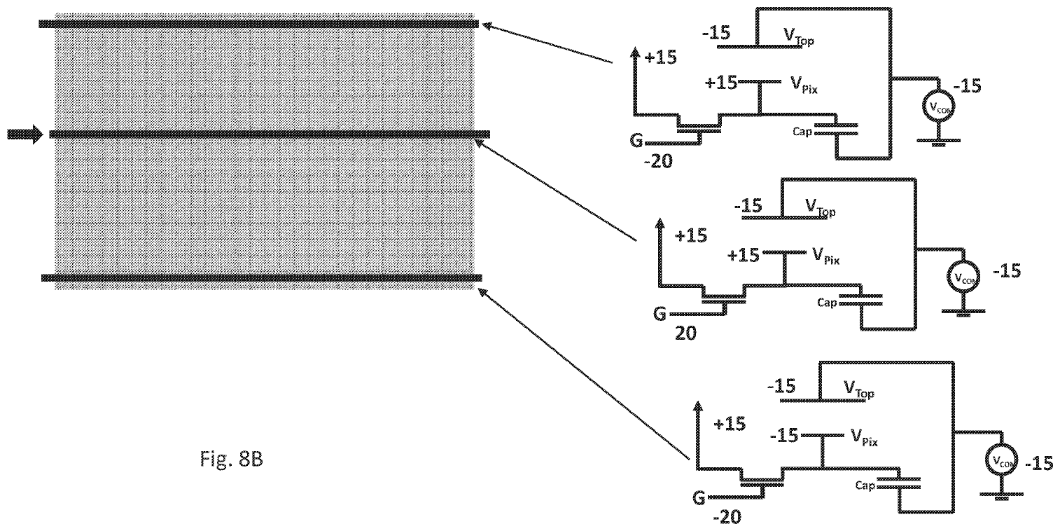

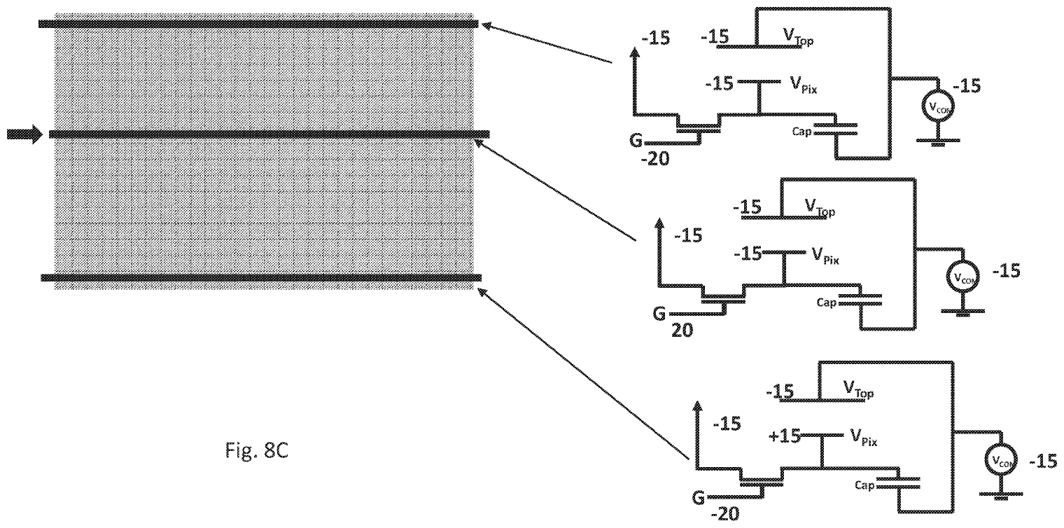

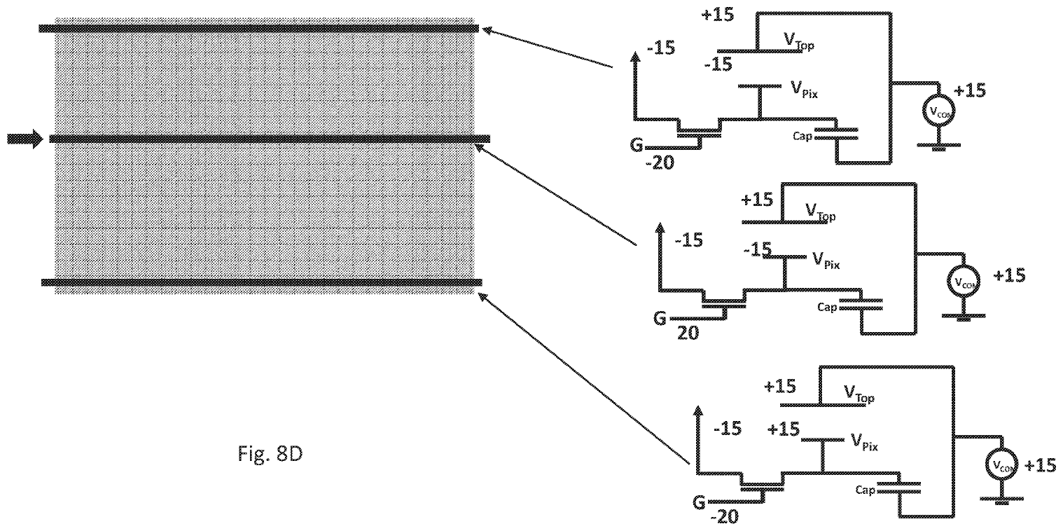

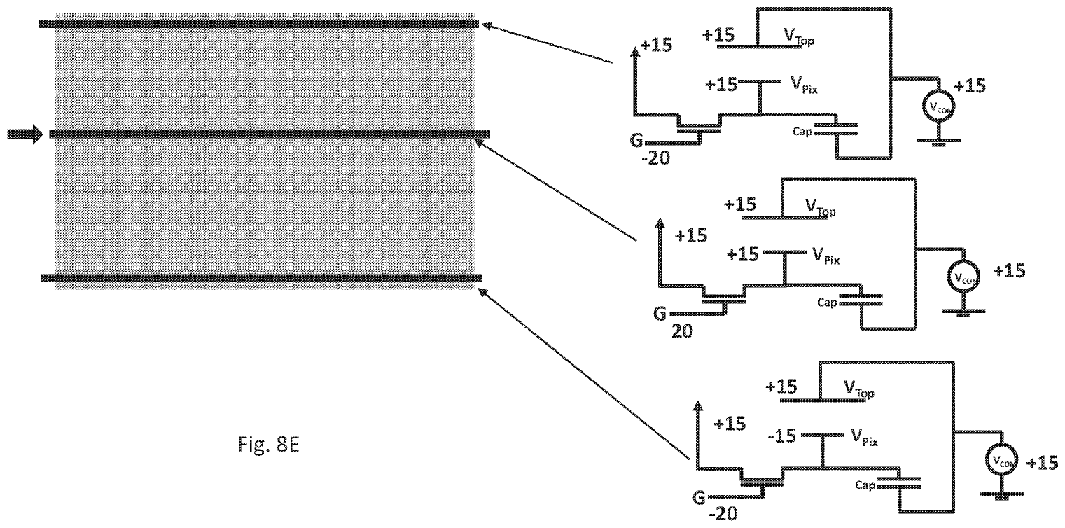

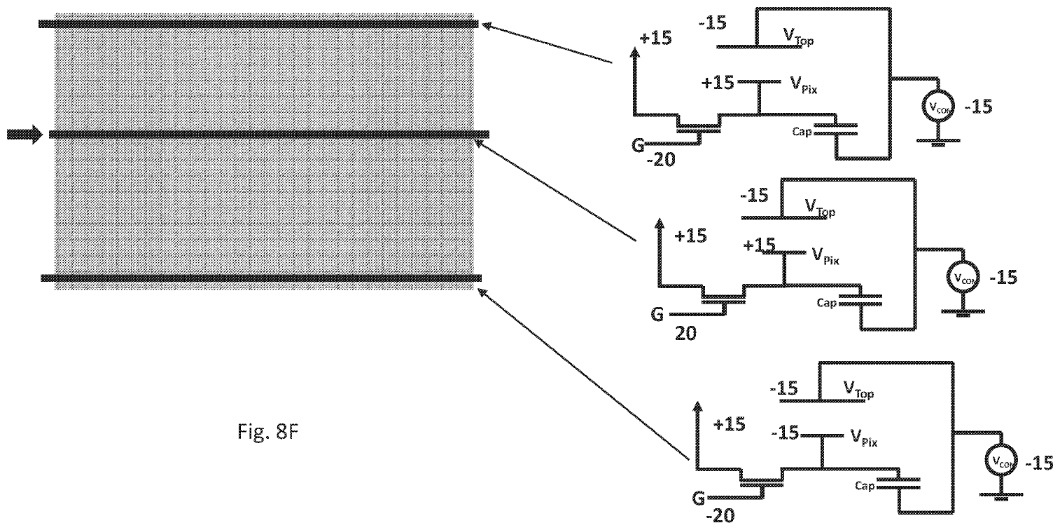

FIG. 5A illustrates the voltage “seen” by a pixel electrode when top plane switching is used without intervening zero frames. Note that the time axis for FIG. 5A is much shorter than FIG. 7A or 8A. As shown in FIG. 5A, when the voltage on the medium is −30V, but intended to be switched to 30V, a scan line delivers a voltage of +15V, while the V_{COM} line, which is also V_{TOP}, receives a voltage of −15V. When the gate of the TFT is opened with a high positive pulse, the pixel electrode “sees” +15V from the scan line, and the medium “sees” +30V. However, before the gate is opened a second time the top plane (i.e., V_{COM}) is switched again. This often happens when the pixel in question in in the lower right-hand corner of the array, as described in FIGS. 5B-5D, below. When V_{COM} goes from −15V to +15V, however, the pixel electrode jumps 30V in absolute value relative to its surrounds to +45V, even though the voltage relative to the top plane remains the same. Functionally, this spike in voltage on the pixel electrode is due to the capacitive coupling between the TFT and V_{COM}. Such a spike can damage the TFT and or the pixel electrode. While not shown in FIG. 5A, it is also possible to achieve V_{PIX} of −45V when the pixel and top plane are addressed in the reverse order.

The location-dependent effects of top plane switching are further detailed in FIGS. 5B-5D. FIG. 5B illustrates the voltages at various points in exemplary equivalent circuit of three different pixels driven as shown in FIG. 5A. The gate of the top pixel has already opened and closed while V_{com} is at −15V. The gate of the middle pixel is currently open while V_{com} is at −15V. The gate of the bottom pixel has not yet opened while V_{com} is at −15V FIG. 5C illustrates the voltages at various points in exemplary equivalent circuit of a three different pixels driven as shown in FIG. 8A. The gate of the top pixel has already opened and closed while V_{com} is at +15V. The gate of the middle pixel is currently open while V_{com} is at +15V. The gate of the bottom pixel has not yet opened while V_{com} is at +15V. Because of the short amount of time since the gate of the bottom pixel was opened, the voltage “seen” by the pixel electrode in the bottom pixel is actually quite high ˜45V FIG. 5D illustrates the voltages at various points in exemplary equivalent circuit of a three different pixels after driving as in FIG. 5A and attempting to return to the initial state of V_{com}=−15V. The gate of the top pixel has already opened and closed while V_{com} is at −15V. The gate of the middle pixel is currently open while V_{com} is at −15V. The gate of the bottom pixel has not yet opened while V_{com} is at −15V. Because of the short amount of time since the gate of the bottom pixel was opened, the voltage “seen” by the pixel electrode in the bottom pixel is actually quite low −45V.

In particular, because the top electrode is not pixelated (i.e., it is a single electrode), it is not possible to independently switch the top electrode voltage above each pixel in a coordinated way. In general, when row-by-row, top-to-bottom switching is used, as is standard in AM-TFT driving, the top row will often be switched (i.e., the gate opened) immediately after the top electrode voltage is changed. This is shown in FIG. 5B. At some later time after the top row is addressed, subsequent rows are addressed, as indicated by the arrow in FIG. 5B. However, especially for large arrays, there is sufficient time for the V_{COM} voltage to capacitively-couple through the storage capacitor and pull V_{PIX} to V_{COM}. When the last row of pixels are updated, however, the pixel electrode will jump from −15V (pulled down by V_{COM}) to +15V when the gate is opened (ΔV=30V) and then once the next frame starts, V_{COM} adds an additional +15V for a total boost of 45V with respect to ground. See 5C. While the medium voltage across all pixels is roughly correct for all of the pixels in the array, a good portion of the pixels see large swings in absolute voltage. Of course, this process can work in reverse to pull the absolute voltage of a pixel very negative, as shown in FIG. 5D.

A second problem that is observed with top plane switching for larger area active matrix switching is that, even though the voltage between the pixel electrode and the top electrode is “correct” for much of the frame, the total impulse (voltage x time), which ultimately determines the response of the droplet is not the same between the pixels in the first row of the array and the pixels in the last row of the array. This phenomenon is illustrated in FIG. 6A, FIG. 6A illustrates a typical “left to right, top to bottom” scan pathway used with active matrix backplanes. When this pathway is used (alone) with top plane switching, the impulse (voltage x time) experienced by a given pixel is position dependent, when the pixels are driven in a row-by-row fashion. As a result, the material adjacent the pixel electrodes (e.g., electrophoretic medium or electrowetting droplets) will experience a position-dependent environment.

In FIG. 6A, the correct “state” is represented by black and the incorrect state is white. While it is an exaggeration to show that the top left-hand corner is switched to the correct state while the lower right-hand corner is not switched at all in a single frame, it is not an exaggeration to say that during the course of a long update, having a traditional “left to right, top to bottom” scan pathway, the cumulative slippage of the impulses can have undesired consequences. This problem is especially acute for applications such as digital electrowetting wherein the storage capacitors at the upper right of FIG. 6A benefit from the extra time for charging (or discharging) as the correct voltage. When a complex series of droplet movements is programmed whereby a chain of equally-spaced droplets is to traverse the edges of the electrowetting panel, the droplet spacing changes during the program. Ultimately, this “slippage” can result in a final reaction droplet not being in the correct detection zone at the end of a protocol or worse, a droplet missing combination with another reagent in the middle of an assay.

It is also beneficial to have consistent voltage environments on an electrowetting array when advanced steps, such as droplet splitting, are being used. In some instances, a droplet in the upper left of the pixel array will split differently than a droplet in the lower right of the pixel array. Such errors can result in, for example, the wrong number of molar species being carried through to subsequent droplet processing steps. Additionally, it has been observed that closer to the bottom rows of the array, droplets sometime lose part (or all) of their driving voltage during the scan of the next frame such that full actuation is not achieved. Such slippage can result in droplets actually residing at the wrong location on the array in the middle of a protocol. Accordingly, in a subsequent reaction step, one of the reagents may be missing, or the wrong reagent may be used.

In a conventional system, as illustrated in FIG. 6A, the first gate line, n, of m total lines that is addressed works the best of any line, and every line after that works decreasingly well. The last group of addressed gate lines, i.e., row m, performs poorly because after the last gate line is addressed, the top plate voltage is switched to a new different voltage. When the top plate is switched to a new voltage, the storage capacitor of last pixel addressed has had the least time to apply its charge to the pixel undisturbed in the case of the last pixel only one line scan time. The first pixel, by contrast, has had a full m number of line scan times to transfer charge undisturbed. As the number of gate lines m gets larger, the non-uniformity gets worse.

One advantageous solution to this shortcoming is to change the pattern of addressing the gate lines to help alleviate this non-uniformity, thereby creating a “superframe” of driving that involves more than one scan of each gate lines for each voltage and more than one pattern of addressing the lines to aid uniformity. Of course, adding additional update pathing between top plane updates increases the length of each frame. Nonetheless, in many applications, the extra time is acceptable to avoid under-switching some of the pixels, as described above.

In some embodiments of the present disclosure, the “superframe” involves a first frame where the gate lines start at the first line n and proceeds in the normal mode of operation iterating one at a time n+1, n+2 etc. to the last line n=m where m is the number of gate lines. In the second frame of the superframe, the mth gate line is the first line addressed and the gate driver iterates in reverse starting at m, to m−1, m−2, and ending with n, the first line. In other words, the update involves two steps. A first step is to scan in the “left to right, top to bottom” scan pathway. The second step is to scan in reverse, i.e., “right to left, bottom to top.” By having this arrangement where the iteration goes through the gate lines forward and then backwards before the top plane voltage is changed the uniformity of top plane switching of the panel is dramatically increased. A two step pathway is illustrated in FIG. 6B, however other pathways, such as “left to right, bottom to top” will also work, and may be easier for the controller to process. Regardless, the last row gets the first charge injection to the storage capacitor at the end of the first frame but gets a second charge injection at the beginning of the second frame. This moves all of the pixels much closer to balance for amount of charge over time on each pixel, as depicted in FIG. 6B.

An embodiment of the present disclosure exemplified in FIG. 6B is compatible with currently available commercial gate drivers, as well as “all in one” scan/gate drivers. For example, the TFT gate driver of the EK72601 chip (E Ink Corporation) has a selection for scanning direction 1-825 or 825-1. For purposes of this example gate line I will be called the top and line 825 or highest number will be the referred to as the bottom. The gate driving superframe would go as follows, set the top plane to +15V or −15V depending on whether the + or −high voltage potential is requested, a gate scan pulse initiates the scanning of the gate lines one at a time, then the initial gate scan would proceed and scan through the gate lines in order 1-825 or less depending on the size of the array. Then the select for the direction of the gate scan would be changed and a second gate start pulse signal would begin a second scan of the gate lines, this time reversed direction from line 825-1 or for the 5.61″ panel from 504-1. Only after scanning the gates from top to bottom and bottom to top would the top plane voltage then be changed to continue through additional pulses of the AC drive sequences used for the DMF driving.

In some embodiments, the performance shortcomings and risks to damage can be alleviated by inserting “rest” or “zero” frames between top plane switches. The zero frames may actually take VCOM and VS to 0V, or some nominal voltage value, or VCOM can be matched to VS for one frame or VS can be matched to VCOM for one frame. The idea is that as the top plane voltage changes, it is possible to prevent large voltage spikes on as yet un-scanned pixels, which could cause those pixels to leak and/or lose their charge and/or fail. In some embodiments, the best results are found when a single frame is inserted where all of the scan lines are fed the identical voltage as the last top electrode voltage and all of the TFTs are gated once. In some embodiments, all of the gates may be opened simultaneously or nearly simultaneously. Of course, adding additional frames to an optical waveform or an electrowetting drive protocol increase the time to complete the task.

FIG. 7A illustrates the voltage “seen” by a pixel electrode when top plane switching is used but V_{com} and V_{S} are returned to zero volts for a frame between switching the top plane from low voltage to high voltage. FIG. 7B illustrates the voltages at various points in exemplary equivalent circuit of a three different pixels driven as shown in FIG. 7A. The gate of the top pixel has already opened and closed while V_{com} is at −15V. The gate of the middle pixel is currently open while V_{com} is at −15V. The gate of the bottom pixel has not yet opened while V_{com} is at −15V FIG. 7C illustrates the voltages at various points in exemplary equivalent circuit of a three different pixels driven as shown in FIG. 7A. The gate of the top pixel has already opened and closed while V_{S} and V_{com} are at 0V. The gate of the middle pixel is currently open while V_{S} and V_{com} are at 0V. The gate of the bottom pixel has not yet opened while V_{S} and V_{com} are at 0V. Because of the short amount of time since the gate of the bottom pixel was opened, the voltage “seen” by the pixel electrode in the bottom pixel is higher than 0V, but within the operational range for an a-Si transistor. FIG. 7D illustrates the voltages at various points in exemplary equivalent circuit of a three different pixels driven as shown in FIG. 7A. The gate of the top pixel has already opened and closed while V_{com} is at +15V. The gate of the middle pixel is currently open while V_{com} is at +15V. The gate of the bottom pixel has not yet opened while V_{com} is at +15V FIG. 7E illustrates the voltages at various points in exemplary equivalent circuit of a three different pixels driven as shown in FIG. 7A. The gate of the top pixel has already opened and closed while V_{S} and V_{com} are at 0V. The gate of the middle pixel is currently open while V_{S} and V_{com} are at 0V. The gate of the bottom pixel has not yet opened while V_{S} and V_{com} are at 0V. Because of the short amount of time since the gate of the bottom pixel was opened, the voltage “seen” by the pixel electrode in the bottom pixel is lower than 0V, but within the operational range for an a-Si transistor. FIG. 7F illustrates the voltages at various points in exemplary equivalent circuit of a three different pixels being returned to the condition of FIG. 7B.

FIG. 7A shows three frames of switching where the voltage on the medium (V_{FPL}/V_{EW}; electro-optic medium or droplet) is switched from +30V to −30V. The frames preceding the +30V and following the −30V are not actually important for the purpose of explanation. The three frames could be part of a reset pulse for an electrophoretic medium, part of a color addressing pulse of an electrophoretic medium, or part of an AC driving wave for an electrowetting device. In the example of FIG. 7A, V_{COM} and V_{S} are both taken to 0V for a single frame, resulting in the voltage on the medium also experiencing a frame of 0V. As in FIG. 5A, the pixel experiencing these pulses is not in the first row of electrodes, thus V_{COM} and V_{S} are switched some time before the gate pulse arrives. Only after the gate is opened can V_{PIX} to go to V_{S}. Before the gate is opened, however, V_{PIX} is capacitively-coupled to Vcont, and drifts toward V_{COM}. Thus when the gate opens, there is still a sizeable jump in the absolute voltage on the pixel electrode, i.e., going to +30V. While this is large, +30V is not out of the operating range of the system and is less likely to cause damage to the TFT or pixel electrode. When the top-plane is finally switched after the zero frame, V_{PIX} undergoes another spike, however this time it is only to +15V. To some extent, the +45V spike shown in FIG. 5A has been distributed over two frames, which decreases the risk of damage to the device. Similar to FIGS. 5B-5D), the voltages on various locations of the circuit can be identified depending upon the row of the pixel and the stage of the update. FIG. 7B-7D show the sequence of the first three frames of FIG. 7A, FIG. 7E shows another zero frame insertion and FIG. 7F is a return to the original state of FIG. 7B.

It is understood that, even though the corresponding −30V to +30V pulse sequences are not shown in the figures, the driving polarity is arbitrary. Thus, the polarity of the pulse sequences can be flipped in order to achieve the same electrical performance, but with the opposite polarity. Of course, flipped polarities may have a real effect on the electrophoretic propulsion, i.e., switching from white to black instead of from black to white, or causing a droplet to stay on a pixel electrode rather than move to an adjacent pixel electrode. Nonetheless, the driving waveforms and the methods of driving are identical except for the polarity of the voltage. Additionally, the pulse sequences described may be spaced apart with intervening frames of no voltage, for example, to stretch out the waveform. The sequences can also be repeated any number of times for the sake of repetitive driving. The sequences described herein may also be combined as desired.

An alternative method of decreasing the strain on the TFT circuit and improving driving consistency is to take V_{S} to V_{COM} between top plane switches. This method is illustrated in FIGS. 8A-8E. FIG. 8A illustrates the voltage “seen” by a pixel electrode when top plane switching is used but V_{com} and V_{S} are “shorted” to each other between switching the top plane from low voltage to high voltage. (Often, V_{com} and V_{S} are not actually shorted but provided the same voltage from the controller.) FIG. 8B illustrates the voltages at various points in exemplary equivalent circuit of a three different pixels driven as shown in FIG. 8A. The gate of the top pixel has already opened and closed while V_{com} is at −15V. The gate of the middle pixel is currently open while V_{com} is at −15V. The gate of the bottom pixel has not yet opened while V_{com} is at −15V FIG. 8C illustrates the voltages at various points in exemplary equivalent circuit of a three different pixels driven as shown in FIG. 5A. The gate of the top pixel has already opened and closed while V_{S}=V_{com}=−15V. The gate of the middle pixel is currently open while V_{S}=V_{com}=−15V. The gate of the bottom pixel has not yet opened while V_{S}=V_{com}=−15V. Because of the short amount of time since the gate of the bottom pixel was opened, the voltage “seen” by the pixel electrode in the bottom pixel is higher than 0V, but because V_{S}=V_{com}=−15V, the pixel electrode is only “seeing” +15V, which is not only within operational range for an a-Si transistor, but the lack of an impulse on the pixel electrodes in the last row diminished inhomogeneities in droplet movement. FIG. 8D illustrates the voltages at various points in exemplary equivalent circuit of a three different pixels driven as shown in FIG. 8A. The gate of the top pixel has already opened and closed while V_{com} is at +15V. The gate of the middle pixel is currently open while V_{com} is at −+15V. The gate of the bottom pixel has not yet opened while V_{com} is at +15V. FIG. 8E illustrates the voltages at various points in exemplary equivalent circuit of a three different pixels driven as shown in FIG. 8A. The gate of the top pixel has already opened and closed while V_{S}=V_{com}=15V. The gate of the middle pixel is currently open while V_{S}=V_{com}=15V. The gate of the bottom pixel has not yet opened while V_{S}=V_{COM}=15V. Again, the voltage “seen” by the bottom pixel is only −15V FIG. 8F illustrates the voltages at various points in exemplary equivalent circuit of a three different pixels being returned to the condition of FIG. 8B.

As shown in FIGS. SA-8E, by having V_{S} “follow” V_{COM} by one frame, prior to a top plane switch, the total absolute voltage on the pixel electrode is even further diminished, reaching a peak of +15V and −15V. This method can also be referred to as a V_{S} pre-pulse method because the V_{S} voltage level is simple the next V_{COM}, but one frame early. Again, as in FIG. 7A, the total voltage on the medium goes to zero between frames. A further benefit is that, for the later pixel rows, the equilibration of V_{S} and V_{COM} is quicker because there is less excess charge on V_{PIX} to remove. The details of switching V_{FPL}/V_{EW} from 30V to −30V and back again are detailed in FIGS. 7B-7E. Theoretically, it is equivalent to match V_{COM} to V_{S} during the zero frame, however because of the speed of the transistor gate opening, it is often better to have V_{S} switch to match the previous V_{COM} before a new V_{COM} is set.

For the purposes of electro-optic material updates and droplet driving, e.g., with an electrowetting device, it is possible to “cheat” my not inserting a zero frame between each and every top-plane switch. Such a cheat may increase the duty cycle of a driving protocol because there are not as many “dead” frames in between the driving frames. Table 1, below, uses the insights from the zeroing strategy in an electrowetting device to develop alternative waveform is that also attempt to minimize the actuation compromise. Experimentally, waveform 1 worked better than a waveform without any zero frames, but waveforms 2-4 were found to be both more stable and quicker. Even though these waveforms contain transitions that are seemingly problematic, they balance the addition of zero frames with actuation time (during a zero frame no meaningful actual occurs). Apparently the excess charges dissipate sufficiently quickly that the zero frames can make up for residual charges from previous high to low (low to high) top plane voltage switches. It did appear that waveforms with more than three switches between zero frames were not as effective as inserting a zero between every high-low switch.

TABLE 1
Empirical study of number of zero frames inserted in AC waveform

| Waveform | Frame Sequence | −30 → 30 | 30 → −30 | Active:Inactive | Rating |
|---|---|---|---|---|---|
| 1 | 30, 0, −30, 0, 30, | No | No | 1:1 | Good |
| | 0, −30, 0 . . . | | | | |
| 2 | 30, −30, 0, 30, −30, 0 . . . | No | Yes | 2:1 | Better |
| 3 | −30, 30, 0, −30, 30, 0 . . . | Yes | No | 2:1 | Better |
| 4 | 30, −30, 0, −30, 30, 0, | Yes | Yes | 2:1 | Better |
| | 30 . . . | | | | |
| 5 | 30, −30, 30, 0, −30, | Yes | Yes | 3:1 | Good |
| | 30, −30, 0 . . . | | | | |
| 6 | 30, −30, 0, 30, −30, 30, | Yes | Yes | 5:2 | Fair |
| | 0, −30, 30, 0, −30, | | | | |
| | 30, −30, 0, 30, −30, 0 . . . | | | | |

Thus, the present disclosure provides for improved top plane switching for driving electrowetting devices. Having thus described several aspects and embodiments of the technology of this present disclosure, it is to be appreciated that various alterations, modifications, and improvements will readily occur to those of ordinary skill in the art. Such alterations, modifications, and improvements are intended to be within the spirit and scope of the technology described in the present disclosure. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The disclosure includes the embodiments as shown below:

1. A method of driving an electrowetting device comprising a top electrode, a backplane, and a microfluidic workspace between the top electrode and the backplane, the backplane including an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode, wherein a controller provides time-dependent voltages to the gate line, the scan line, the top electrode, and the storage capacitor, wherein a first side of the storage capacitor is coupled to the pixel electrode and a second side of the storage capacitor is coupled to the controller, the method of driving comprising (in order):
a) providing a first high voltage to the scan line and a first low voltage to the top electrode and the second side of the storage capacitor;
b) providing a first gate pulse sufficient to open the TFT;
c) after the first gate pulse, providing a zero voltage to the scan line, the top electrode and the second side of the storage capacitor;
d) providing a second gate pulse sufficient to open the TFT;
e) after the second gate pulse, providing a second low voltage to the scan line and a second high voltage to the top electrode and the second side of the storage capacitor; and
f) providing a third gate pulse sufficient to open the TFT.

2. The method of embodiment 1, wherein steps a)-f) are completed in three subsequent frames.

3. The method of embodiment 1 or 2, wherein the top electrode is light-transmissive.

4. The method of embodiments 1-3, wherein the top electrode and the second side of the storage capacitor are electrically coupled to a common node.

5. The method of embodiments 1-4, wherein the TFT is fabricated from amorphous silicon.

6. The method of embodiments 1-5, wherein the first and second high voltage are +15V.

7. The method of embodiments 1-6, wherein the first and second low voltages are −15V.

8. The method of embodiments 1-7, wherein the backplane and the top electrode are coated with a hydrophobic material, wherein the hydrophobic materials are adjacent the microfluidic workspace.

9. The method of embodiment 8, wherein the backplane additionally comprises a dielectric layer between the pixel electrodes and the hydrophobic material.

10. The method of embodiments 1-9, wherein the microfluidic workspace further comprises a plurality of aqueous droplets surrounded by a continuous hydrophobic medium.

11. A method of driving an electrowetting device comprising a top electrode, a backplane, and a microfluidic workspace between the top electrode and the backplane, the backplane including an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode, wherein a controller provides time-dependent voltages to the gate line, the scan line, the top electrode, and the storage capacitor, wherein a first side of the storage capacitor is coupled to the pixel electrode and a second side of the storage capacitor is coupled to the controller, the method of driving comprising (in order):
a) providing a first high voltage to the scan line and a first low voltage to the top electrode and the second side of the storage capacitor;
b) providing a first gate pulse sufficient to open the TFT;
c) after the first gate pulse, providing a second low voltage to the scan line;
d) providing a second gate pulse sufficient to open the TFT;
e) after the second gate pulse, providing a second high voltage to the top electrode and the second side of the storage capacitor; and
f) providing a third gate pulse sufficient to open the TFT.

12. The method of embodiment 11, wherein steps a)-f) are completed in three subsequent frames.

13. The method of embodiments 11 or 12, wherein the top electrode is light-transmissive.

14. The method of embodiments 1-13, wherein the top electrode and the second side of the storage capacitor are electrically coupled to a common node.

15. The method of embodiments 11-14, wherein the TFT is fabricated from amorphous silicon.

16. The method of embodiment 15, wherein the first and second high voltage are +15V.

17. The method of embodiment 16, wherein the first and second low voltages are −15V.

18. The method of embodiments 11-17, wherein the backplane and the top electrode are coated with a hydrophobic material, wherein the hydrophobic materials are adjacent the microfluidic workspace.

19. The method of embodiment 18, wherein the backplane additionally comprises a dielectric layer between the pixel electrodes and the hydrophobic material.

20. The method of embodiments 11-19, wherein the microfluidic workspace further comprises a plurality of aqueous droplets surrounded by a continuous hydrophobic medium.

21. A method of driving an electrowetting device comprising a top electrode, a backplane, and a microfluidic workspace between the top electrode and the backplane, the backplane including an array of pixel electrodes, wherein each pixel electrode is coupled to a thin film transistor (ITT) and a storage capacitor, the TFT including a source, a gate, and a drain, wherein the gate is coupled to a gate line, the source is coupled to a scan line, and the drain is coupled to the pixel electrode, wherein a controller provides time-dependent voltages to the gate line, the scan line, the top electrode, and the storage capacitor, wherein a first side of the storage capacitor is coupled to the pixel electrode and a second side of the storage capacitor is coupled to the controller, the method of driving comprising (in order):
a) providing a first high voltage to the scan line and a first low voltage to the top electrode and the second side of the storage capacitor;
b) providing a first gate pulse sufficient to open the TFT;
c) after the first gate pulse, providing a second high voltage to the top electrode and the second side of the storage capacitor;
d) providing a second gate pulse sufficient to open the TFT;
e) after the second gate pulse, providing a second low voltage to the scan line;
and
f) providing a third gate pulse sufficient to open the TFT.

22. The method of embodiment 21, wherein steps a)-f) are completed in three subsequent frames.

23. The method of embodiments 21 or 22, wherein the top electrode is light-transmissive.

24. The method of embodiments 21-23, wherein the top electrode and the second side of the storage capacitor are electrically coupled to a common node.

25. The method of embodiments 21-24, wherein the TFT is fabricated from amorphous silicon.

26. The method of embodiment 25, wherein the first and second high voltage are +15V.

27. The method of embodiment 26, wherein the first and second low voltages are +15V.

28. The method of embodiment 21-27, wherein the backplane and the top electrode are coated with a hydrophobic material, wherein the hydrophobic materials are adjacent the microfluidic workspace.

29. The method of embodiment 28, wherein the backplane additionally comprises a dielectric layer between the pixel electrodes and the hydrophobic material.

30. The method of embodiment 21-29, wherein the microfluidic workspace further comprises a plurality of aqueous droplets surrounded by a continuous hydrophobic medium.

31. A method of driving an electrowetting device comprising a top electrode, a backplane, and a microfluidic workspace between the top electrode and the backplane, the backplane including an array of pixel electrodes, wherein each pixel electrode is coupled to a thin film transistor (TFT) and a storage capacitor, the TFT including a source, a gate, and a drain, wherein the gate is coupled to a gate line, the source is coupled to a scan line, and the drain is coupled to the pixel electrode, wherein the controller provides time-dependent voltages to the gate line, the scan line, and the top electrode in order to execute the following steps (in order):
(a) provide a first voltage to the top electrode;
(b) provide a specific voltage to each electrode of the array of pixel electrodes in a first sequential order, wherein at least 10 pixels of the array have specific voltages different from the majority of the pixel electrodes;
(c) provide a specific voltage to each electrode of the array of pixel electrodes in a second sequential order, wherein the order of providing specific voltages to pixel electrodes in the second sequential order is a reverse order of the first sequential order, and wherein each pixel receives the same specific voltage in both the first sequential order and the second sequential order; and
(d) provide a second voltage different from the first voltage to the top electrode, wherein the pixel electrodes do not receive another voltage from the controller between steps (b) and (c).

32. The method of embodiment 31, wherein the TFT is fabricated from amorphous silicon.

33. The method of embodiments 31-32, wherein the top electrode is light-transmissive.

34. The method of embodiments 31-33, wherein the first voltage is +15V and the second voltage is −15V.

35. The method of embodiments 31-33, wherein the first voltage is −15V and the second voltage is +15V.

36. The method of embodiments 31-35, wherein at least 100 pixels of the array have specific voltages different from the majority of the pixel electrodes.

37. The method of embodiments 31-36, wherein the backplane and the top electrode are coated with a hydrophobic material, wherein the hydrophobic materials are adjacent the microfluidic workspace.

38. The method of embodiment 37, wherein the backplane additionally comprises a dielectric layer between the pixel electrodes and the hydrophobic material.

39. The method of embodiments 31-38, wherein the microfluidic workspace further comprises a plurality of aqueous droplets surrounded by a continuous hydrophobic medium.

1. An electrowetting device, comprising:
a top electrode;
a plurality of thin film transistors (TFTs) each of the plurality of TFTs include a source, a gate, and a drain;
a plurality of storage capacitors;
a backplane comprising a plurality of addressable pixel electrodes, each of the addressable pixel electrodes electrically coupled to the drain of a respective one of the plurality of TFTs and one of the plurality of storage capacitors;
a microfluidic workspace between the top electrode and the backplane;
a plurality of gate lines, the gate of each of the plurality of TFTs electrically coupled to a respective one of the plurality of gate lines,
a plurality of scan lines, the source of each of the plurality of TFTs electrically coupled to a respective one of the plurality of scan lines; and
a controller electrically coupled to the plurality of gate lines, the plurality of scan lines, the top electrode, and the plurality of storage capacitors to provide time-dependent voltages thereto, the controller further configured or programmed to perform top plane switching to drive the electrowetting device by:
driving the top electrode with a first voltage;
driving the plurality of gate lines with a pulsed waveform to open the plurality of TFTs;
driving the plurality of storage capacitors and the plurality of scan lines with a low level voltage for at least one period of the pulsed waveform; and
driving the top electrode with a second voltage.

2. The electrowetting device of claim 1, wherein driving the plurality of storage capacitors and the plurality of scan lines with a low level voltage for one period of the pulsed waveform returns a voltage level at the plurality of storage capacitors to zero volts and returns a voltage level at the plurality of scan lines to zero volts.

3. The electrowetting device of claim 1, wherein driving the plurality of gate lines with the pulsed waveform to open the plurality of TFTs includes sequentially driving the plurality of gate lines in a first scan direction with the first pulsed waveform and sequentially driving the plurality of gate lines in a reversed scan direction with a second pulsed waveform.

4. The electrowetting device of claim 1, wherein the controller is configured to drive the electrowetting device by
a) providing a first high voltage to the plurality of scan lines and a first low voltage to the top electrode and a second side of the plurality of storage capacitors;
b) providing a first gate pulse sufficient to open the plurality of TFTs;
c) after the first gate pulse, providing a zero voltage to the plurality of scan lines, the top electrode and the second side of the plurality of storage capacitors;
d) providing a second gate pulse sufficient to open the plurality of TFTs;
e) after the second gate pulse, providing a second low voltage to the plurality of scan lines and a second high voltage to the top electrode and a second side of the plurality of storage capacitors; and
f) providing a third gate pulse sufficient to open the plurality of TFTs.

5. The electrowetting device of claim 1, wherein the controller is configured to drive the electrowetting device by
a) providing a first high voltage to the plurality of scan lines and a first low voltage to the top electrode and a second side of the plurality of storage capacitors;
b) providing a first gate pulse sufficient to open the plurality of TFTs;
c) after the first gate pulse, providing a second low voltage to the plurality of scan lines;
d) providing a second gate pulse sufficient to open the plurality of TFTs;
e) after a second gate pulse, providing a second high voltage to the top electrode and the second side of the plurality of storage capacitors; and
f) providing a third gate pulse sufficient to open the TFTs.

6. The electrowetting device of claim 1, wherein the controller is configured to drive the electrowetting device by
a) providing a first high voltage to the plurality of scan lines and a first low voltage to the top electrode and a second side of the plurality of storage capacitors;
b) providing a first gate pulse sufficient to open the TFTs;
c) after the first gate pulse, providing a second high voltage to the top electrode and a second side of the storage capacitors;
d) providing a second gate pulse sufficient to open the TFTs;
e) after the second gate pulse, providing a second low voltage to the scan lines; and
f) providing a third gate pulse sufficient to open the TFTs.

7. The electrowetting device of claim 1, wherein the controller is configured to drive the electrowetting device by
(a) providing a first voltage to the top electrode;
(b) providing a specific voltage to each electrode of the plurality of addressable pixel electrodes in a first sequential order;
(c) providing a specific voltage to each electrode of the plurality of addressable pixel electrodes in a second sequential order, wherein the order of providing specific voltages to plurality of addressable pixel electrodes in the second sequential order is a reverse order of the first sequential order, and wherein each pixel of the plurality of addressable pixel electrodes receives the same specific voltage in both the first sequential order and the second sequential order; and
(d) providing a second voltage different from the first voltage to the top electrode.

8. The device of claim 1, wherein the top electrode is light-transmissive.

9. The device of claim 1, wherein the top electrode and a second side of the storage capacitor are electrically coupled to a common node.

10. The device of claim 1, wherein the plurality of TFTs are fabricated from amorphous silicon.

11. (canceled)

12. (canceled)

13. The device of claim 1, wherein the backplane and the top electrode are coated with a hydrophobic material, wherein the hydrophobic material is adjacent the microfluidic workspace.

14. The device of claim 1, wherein the backplane additionally comprises a dielectric layer between the plurality of addressable pixel electrodes and the hydrophobic material.

15. (canceled)

16. A method of driving an electrowetting device comprising:
a top electrode;
a plurality of thin film transistors (TFTs) each of the plurality of TFTs include a source, a gate, and a drain;
a plurality of storage capacitors;
a backplane comprising a plurality of addressable pixel electrodes, each of the addressable pixel electrodes electrically coupled to the drain of a respective one of the plurality of TFTs and one of the storage capacitors;
a microfluidic workspace between the top electrode and the backplane;
a plurality of gate lines, the gate of each of the plurality of TFTs electrically coupled to a respective one of the plurality of gate lines,
a plurality of scan lines, the source of each of the plurality of TFTs electrically coupled to a respective one of the plurality of scan lines; and
a controller electrically coupled to the plurality of gate lines, the plurality of scan lines, the top electrode, and the plurality of storage capacitors to provide time-dependent voltages thereto, the method comprising:
driving the top electrode with a first voltage;
driving the plurality of gate lines with a pulsed waveform to open the plurality of TFTs;
driving the plurality of storage capacitors and the plurality of scan lines with a low level voltage for at least one period of the pulsed waveform; and
driving the top electrode with a second voltage.

17. The method of claim 16 further comprising a method of driving (in order):
a) providing a first high voltage to the plurality of scan lines and a first low voltage to the top electrode and a second side of the plurality of storage capacitors;
b) providing a first gate pulse sufficient to open the plurality of TFTs;
c) after the first gate pulse, providing a zero voltage to the plurality of scan lines, the top electrode and a second side of the plurality of storage capacitors;
d) providing a second gate pulse sufficient to open the plurality of TFTs;
e) after the second gate pulse, providing a second low voltage to the plurality of scan lines and a second high voltage to the top electrode and the second side of the plurality of storage capacitors; and
f) providing a third gate pulse sufficient to open the plurality of TFTs.

18. The method of claim 16 further comprising a method of driving (in order):
a) providing a first high voltage to the plurality of scan lines and a first low voltage to the top electrode and a second side of the plurality of storage capacitors;
b) providing a first gate pulse sufficient to open the plurality of TFTs;
c) after the first gate pulse, providing a second low voltage to the plurality of scan lines;
d) providing a second gate pulse sufficient to open the plurality of TFTs;
e) after the second gate pulse, providing a second high voltage to the top electrode and the second side of the plurality of storage capacitors; and
f) providing a third gate pulse sufficient to open the plurality of TFTs.

19. The method of claim 16 further comprising a method of driving (in order):
a) providing a first high voltage to the plurality of scan lines and a first low voltage to the top electrode and a second side of the plurality of storage capacitors;
b) providing a first gate pulse sufficient to open the plurality of TFTs;
c) after the first gate pulse, providing a second high voltage to the top electrode and the second side of the storage capacitors;
d) providing a second gate pulse sufficient to open the plurality of TFTs;
e) after the second gate pulse, providing a second low voltage to the plurality of scan lines; and
f) providing a third gate pulse sufficient to open the plurality of TFTs.

20. The method of claim 16 further comprising a method of driving (in order):
(a) providing a first voltage to the top electrode;
(b) providing a specific voltage to each electrode of the addressable pixel electrodes in a first sequential order;
(c) providing a specific voltage to each electrode of the addressable pixel electrodes in a second sequential order, wherein the order of providing specific voltages to the addressable pixel electrodes in the second sequential order is a reverse order of the first sequential order, and wherein each of the addressable pixel electrodes receives the same specific voltage in both the first sequential order and the second sequential order; and
(d) providing a second voltage different from the first voltage to the top electrode.

21. (canceled)

22. The method of claim 17, wherein the first and second high voltage are +15V.

23. The method of claim 17, wherein the first and second low voltages are −15V.

24. The method of claim 19 wherein at least 100 pixels of the addressable pixel electrodes have specific voltages different from the majority of the addressable pixel electrodes.
